(19) United States
(12) Patent Application Publication
(10) Pub. No.: US 2022/0027802 A1
(43) Pub. Date: Jan. 27, 2022

(54) MIDSTREAM ITINERARY RECONSTRUCTION SYSTEM

(71) Applicant: Bank of America Corporation, Charlotte, NC (US)

(72) Inventor: Vijaya L. Vemireddy, Plano, TX (US)

(21) Appl. No.: 16/939,140

(22) Filed: Jul. 27, 2020

(51) Int. Cl. G06Q 10/02; G06Q 30/02; G06Q 20/40; G06Q 20/38

(52) U.S. Cl. CPC G06Q 10/025; G06Q 30/0281; G01C 21/3423; G06Q 20/383; G06Q 20/3829; G06Q 20/407

(57) ABSTRACT

A method for remediating a midstream interrupt of an itinerary is provided. The method may include receiving an itinerary and identification documentation from a traveler at a pacted central processing system. The method may include committing the itinerary to a pacted central processing system. The method may include generating a unique identifier that identifies the itinerary and the traveler a the pacted central processing system. The method may include transmitting the unique identifier to the traveler. The method may include anonymously booking itinerary. The anonymous booking may include transmitting an encrypted version of the identification documentation and the unique identifier to one or more service providers. The method may include receiving data relating to an interrupt in the itinerary. The method may include remediating the interrupt to the itinerary.

### FIELD OF TECHNOLOGY

Aspects of the disclosure relate to systems for enhancing travel security.

### BACKGROUND OF THE DISCLOSURE

Travel security has become more important in recent years. Travel service providers, such as hotels, airlines and car rentals may be located in various locations around the globe. These travel service providers cannot consistently be relied upon to protect a traveler's privacy and personally identifiable information. As such, a traveler's personally identifiable information, for example, a traveler's name and credit card information, may become vulnerable when the traveler uses personally identifiable information to book an itinerary. Furthermore, such information may become vulnerable when the traveler uses personally identifiable information while en route.

Conventionally, there is no recourse but for the traveler to provide personally identifiable information to travel service providers. Specifically, many travel service providers require personally identifiable information, such as name and credit card data, to book an itinerary. Many travel service providers also require personally identifiable information in order to secure a rented item, such as a hotel room or rental car, against incidental damage.

Therefore, a system that protects a traveler's anonymity and provides a surety for the service providers would be desirable.

At times, a travel itinerary may be interrupted for a variety of reasons. An interrupt is especially detrimental when the traveler is unknown to the service provider. This is at least because the service provider may have prepared special arrangements for the traveler, committed resources for the traveler or taken steps pursuant to the traveler's use of the service provider services. As such, it would be further desirable for the system to enable remediation of a midstream interrupt of the itinerary.

### SUMMARY OF THE DISCLOSURE

A system for remediating a midstream interrupt of an itinerary is provided. The system may include a receiver. The receiver may be operable to receive an itinerary. An itinerary may include a schedule of events relating to planned travel. The itinerary may include locations to be visited at specific times and methods of transportation to move between locations.

The itinerary may comprise a plurality of legs. Each of the legs may correspond to the travel between a first location and a second location. Each leg may include a first location, a second location and a method of transportation from the first location to the second location. Each leg may also include details relating to lodging at the second location. Such details may include hotel room and car rental details.

The receiver may also be operable to receive identification documentation from a traveler. Identification documentation may include a driver's license, a passport, a biometric identifier—e.g. face scan, iris scan, fingerprint—and another suitable identification documentation.

The system may also include a memory. The memory may be operable to store the itinerary and the identification documentation.

The system may also include a unique identifier generator. The unique identifier generator may be operable to generate a unique identifier. The unique identifier may identify the itinerary and the traveler.

The system may also include a transmitter. The transmitter may be operable to transmit the unique identifier to the traveler. In some embodiments, the unique identifier may be resident on a token on a mobile device associated with the traveler.

The system may also include an itinerary booking module. The itinerary booking module may be operable to anonymously book the itinerary with one or more service providers. The booking may include transmitting an encrypted version of the identification documentation and the unique identifier to the one or more service providers.

The receiver may be further operable to receive data relating to an interrupt in the itinerary. The data may be received from the traveler. The data may be received from one or more service providers.

The system may remediate the interrupt in the itinerary. The remediation may include identifying one or more legs of the itinerary that have not been completed. The remediation may include transmitting an encryption key to the service providers associated with the incomplete legs. The encryption key may enable the service providers to decrypt the identification documentation.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure; and

FIGS. 5A, 5B, 5C, 5D, 5E, 5F and 5G show illustrative diagrams in accordance with principles of the disclosure.

### DETAILED DESCRIPTION OF THE DISCLOSURE

Apparatus and methods for remediating a midstream interrupt of an itinerary is provided.

Methods may include receiving an itinerary from a traveler at a pacted central processing system. The pacted central processing system may a centralized system that communicates with a group of service providers and a group of travelers. The pacted central processing system may link the group of service providers and the group of travelers. The pacted central processing system may enable each of the travelers to maintain anonymity while booking a service provider. The pacted central processing system may enable each service provider to electronically communicate with an anonymous traveler. The pacted central processing system may also enable each traveler to electronically communicate anonymously with a service provider.

Methods may include committing the itinerary to the pacted central processing system. The committing may include a pledge on behalf of the traveler to complete the itinerary. The committing may include one or more assets to be forfeited by the traveler, under certain conditions, in the event that the itinerary is broken by the traveler.

Methods may include generating a unique identifier that identifies the itinerary and the traveler at the pacted central processing system.

Methods may include anonymously booking, using the unique identifier, the itinerary by the pacted central processing system. The booking may include transmitting the unique identifier to one or more service providers identified in the itinerary.

Methods may include receiving, at the pacted central processing system, data relating to an interrupt in the itinerary. The data relating to the interrupt may be received from a service provider. The data relating to the interrupt may be received from the traveler.

Methods may include triggering an alert when the traveler fails to arrive within a predetermined time period at one of the one or more service providers.

Methods may include remediating the interrupt in the itinerary. The remediating may be executed by the pacted central processing system. The remediating may include transmitting an electronic message to the traveler.

The remediating may include transmitting an electronic message to the traveler. The electronic message may include an artificially-intelligent-based replacement itinerary. The artificially-intelligent-based replacement itinerary may be based in part on previous itineraries of the traveler. The artificially-intelligent-based replacement itinerary may be based in part on current events. In some embodiments, the message may include a user-configured replacement itinerary.

The traveler may transmit a response to the electronic message received from the pacted central processing system. The response may include an acceptance of the replacement itinerary. Upon accepting the replacement itinerary within a predetermined time period, the traveler may not forfeit assets to the pacted central processing system.

The remediating may include identifying one or more legs included in the plurality of itinerary legs that are incomplete. The pacted central processing system may transmit an electronic message to at least one service provider associated with the incomplete itinerary legs. The electronic message may include data relating to the interrupt. The pacted central processing system may preemptively cancel bookings at the service provider(s) associated with the incomplete legs.

In some embodiments, the pacted central processing system may lower a reliability rating of the traveler. The rating may be lowered by a predetermined amount. The predetermined amount may correspond to the number of incomplete legs.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

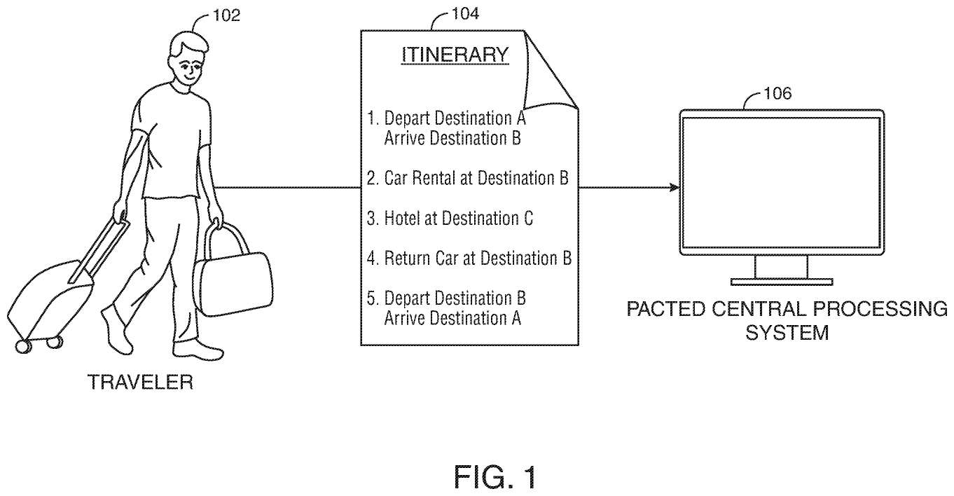

FIG. 1 shows an illustrative diagram. The illustrative diagram shows traveler 102. Traveler 102 may transmit itinerary 104 to pacted central processing system 106.

Itinerary 104 may include a plurality of legs. Leg 1 may include departure from destination A and arrival at destination B. Leg 2 may include car rental at destination B. Leg 3 may include hotel at destination C. Leg 4 may include return car at destination B. Leg 5 may include departure from destination B and arrival at destination A.

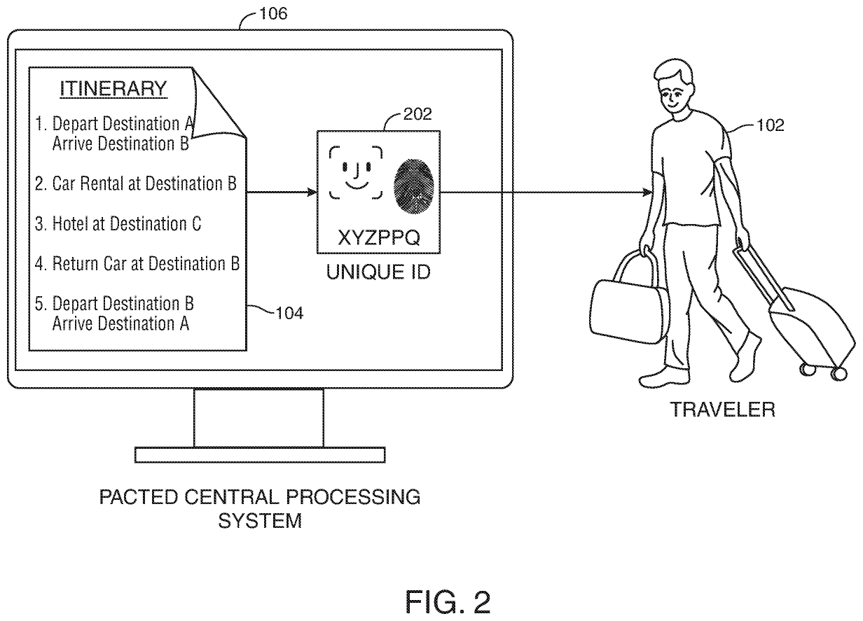

FIG. 2 shows an illustrative diagram. Pacted central processing system 106 may generate unique identifier 202 for traveler 102. Unique identifier 202 may identify traveler 102 and itinerary 104. In some embodiments, unique identifier 202 may include a biometric identifier, such as a fingerprint, iris scan, face scan or other suitable biometric identifier.

Pacted central processing system 106 may store itinerary 104. Pacted central processing system 106 may transmit unique identifier 202 to traveler 102.

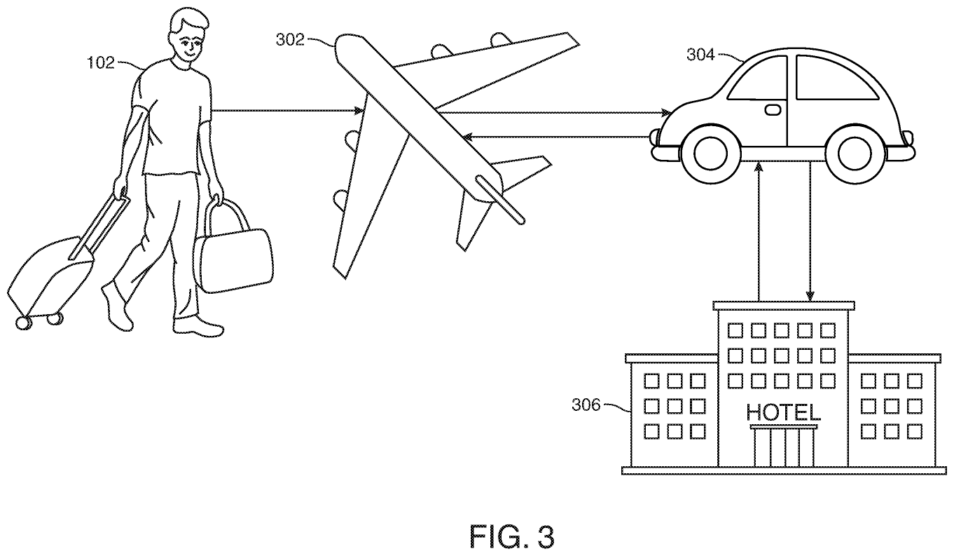

FIG. 3 shows an illustrative diagram. Traveler 102 may travel as indicated in itinerary 104. While en route, traveler 102 may utilize service providers, such as airline 302, car rental 304 and hotel 306.

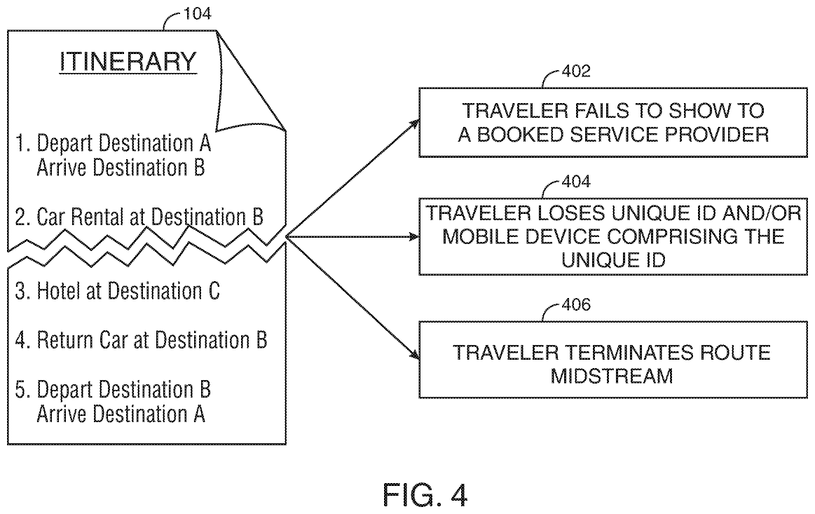

FIG. 4 shows an illustrative diagram. Itinerary 104 may be interrupted. As such, itinerary 104 is shown with a split in the middle of the itinerary. Itinerary 104 may be interrupted after leg 2.

Data relating to the interrupt in the itinerary may be received at pacted central processing system 106 from traveler 102.

Data relating to the interrupt in the itinerary may be received at pacted central processing system 106 from a service provider.

There may be various reasons for a midstream interrupt. Such reasons may include failure of traveler 102 to arrive at a booked service provider, shown at 402. Such reasons may also include when a traveler loses a unique identifier and/or mobile device comprising the unique identifier, shown at 404. As such, traveler 102 is no longer able to utilize the unique identifier to check-in with a service provider. Such reasons may also include traveler 102 terminates route midstream, as shown at 406.

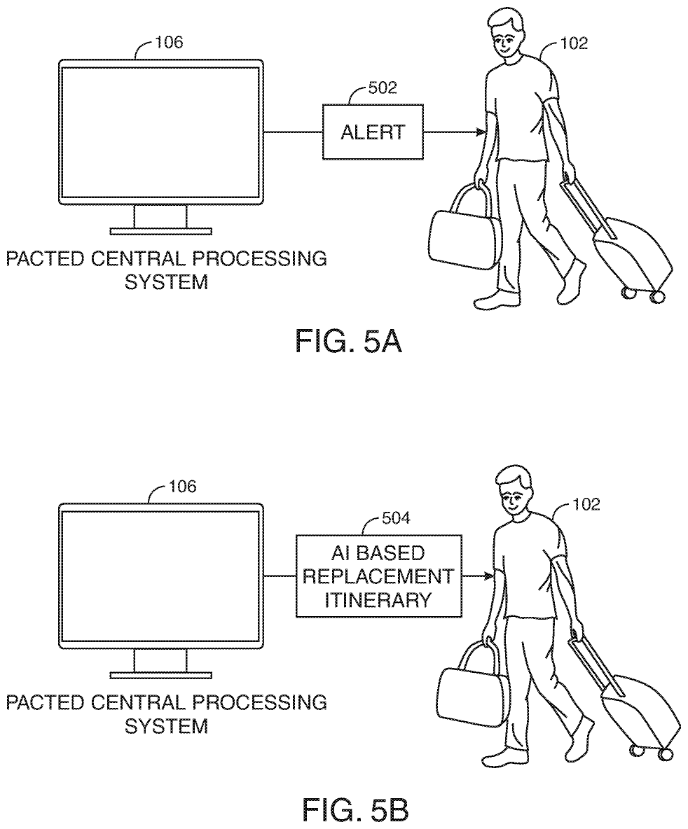

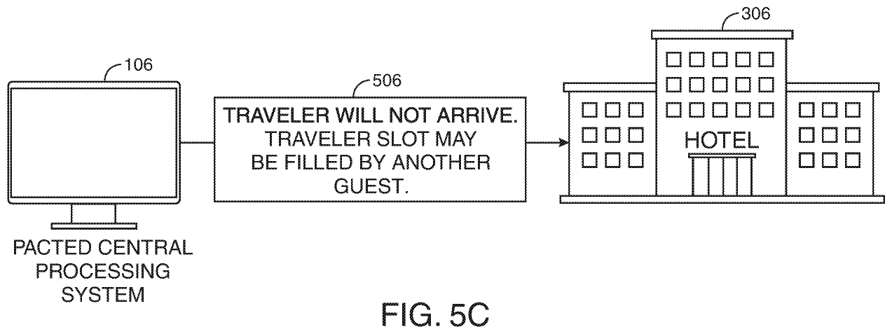

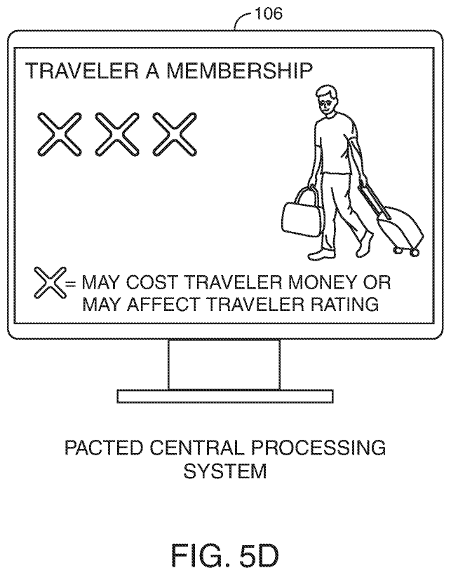

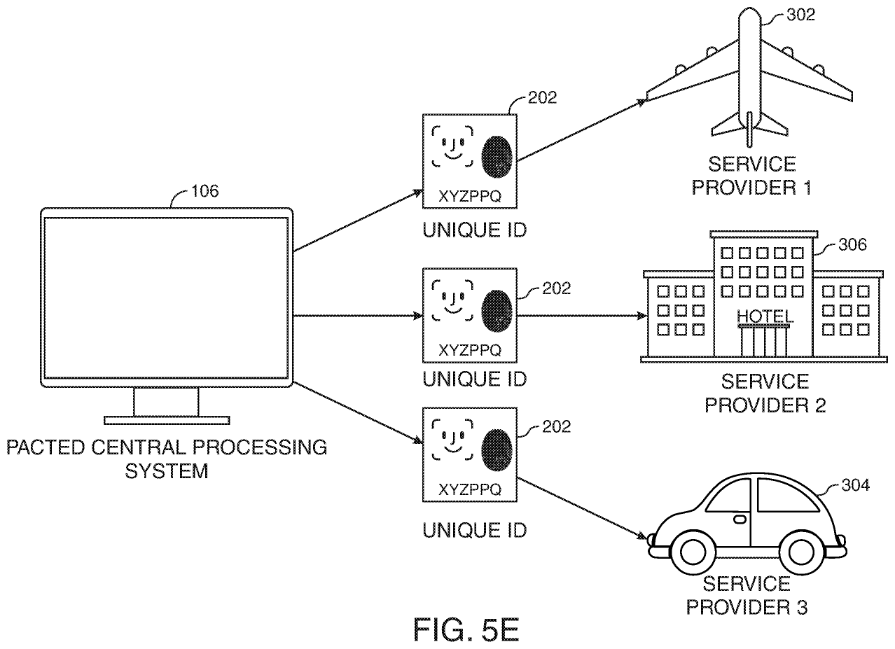

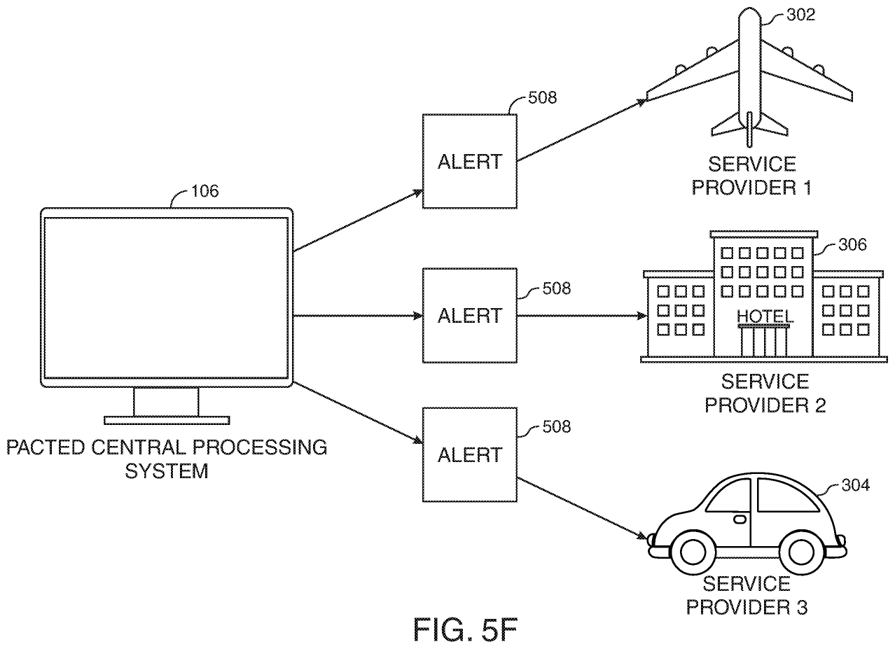

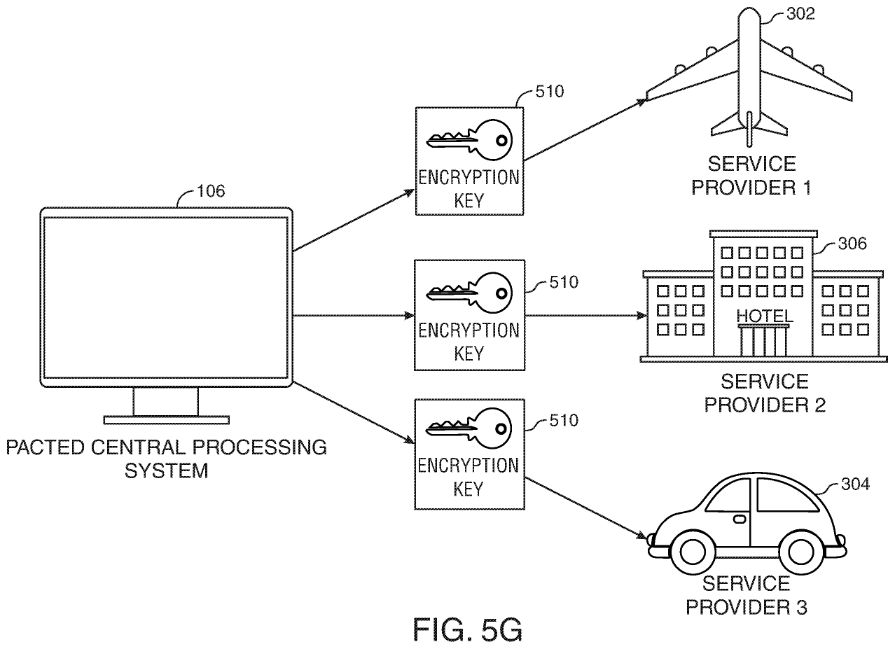

FIGS. 5A-5F show illustrative diagrams. Each of FIGS. 5A-5F show various remediation options for an interrupted itinerary.

FIG. 5A shows pacted central processing system 106 transmits alert 502 to traveler 102. Alert 502 may instruct traveler 102 to notify traveler 102 about the interrupt to itinerary 104.

FIG. 5B shows pacted central processing system 106 transmits an AI (artificially intelligent) based replacement itinerary to traveler 102.

FIG. 5C shows pacted central processing system determines one or more legs of itinerary 104 that have not been completed. As such, pacted central processing system identifies service providers associated with the incomplete itinerary legs. As shown in FIG. 5C, pacted central processing system transmits an electronic alert to hotel 306. The electronic alert may notify hotel 306 that traveler 102 may not arrive. As such, the booked room may be filled by another guest.

FIG. 5D shows that interrupted itinerary may disadvantage a traveler's membership rating. A lower traveler membership rating may cost the traveler fees. A lower traveler membership rating may also affect traveler rating for future itinerary bookings. A lower magnitude traveler membership rating may reduce preferred traveling benefits.

FIG. 5E shows that pacted central processing system 106 may transmit personally identifiable information, such as unique identifier 202 to one or more service providers, such as airline 302, hotel 306 and car rental 304.

In some embodiments, this remediation option may assist traveler 102 in the event that traveler 102 interrupted itinerary 104 because of a lost unique identifier.

FIG. 5F shows that pacted central processing system 106 may transmit alert 508 to one or more service providers, such as airline 302, hotel 306 and car rental 304. The alert may be an electronic alert. The electronic alert may include data relating to the interrupt.

FIG. 5G shows that pacted central processing system 106 may be configured to transmit encryption key 510 to one or more service providers, such as airline 302, hotel 306 and car rental 304.

The encryption key may be used to decrypt encrypted documentation relating to traveler 102. This remediation option may be used in the event that encrypted personally identifiable documentation was sent to the service providers from the pacted central processing system during the anonymous booking.

In certain embodiments, the personally identifiable documentation may remain encrypted, and as such, traveler 102 may remain anonymous as long as the itinerary is uninterrupted. In the event that the itinerary is interrupted, traveler 102 may lose the anonymity status.

In some embodiments, loss of anonymity status may be useful in the event that traveler 102 lost the unique identifier and/or access to the unique identifier, and intends to continue traveling as stated in the itinerary. As such, when traveler 102 arrives at a service provider, traveler 102 may present an identification document, such as a driver's license. Because the service provider has access to personally identifiable information associated with the itinerary, and the service provider receives the identification document from traveler 102, the service provider may locate the reservation associated with the itinerary without receiving the unique identifier.

Thus, a midstream itinerary reconstruction system is provided. Persons skilled in the art will appreciate that the present invention can be practiced by other than the described embodiments, which are presented for purposes of illustration rather than of limitation. The present invention is limited only by the claims that follow.

What is claimed is:

1. A system for remediating a midstream interrupt of an itinerary, the system comprising:
a receiver operable to receive an itinerary and identification documentation from a traveler, said itinerary comprising a plurality of legs;
a memory operable to store the itinerary and the identification documentation;
a unique identifier generator operable to generate a unique identifier, said unique identifier that identifies the itinerary and the traveler;
a transmitter operable to transmit the unique identifier to the traveler;
an itinerary booking module operable to anonymously book the itinerary with one or more service providers by transmitting an encrypted version of the identification documentation and the unique identifier to the one or more service providers;
the receiver is further operable to receive data relating to an interrupt in the itinerary;
a processor that is operable to identify one or more legs included in the itinerary that are incomplete; and
the transmitter is further operable to transmit an encryption key to one or more service providers associated with the incomplete legs.

2. The system of claim 1, wherein the data relating to the interrupt is received from the traveler.

3. The system of claim 1, wherein the data relating to the interrupt is received from at least one of the one or more service providers.

4. The system of claim 1, wherein the unique identifier is resident on a token on a mobile device associated with the traveler.

5. A method for remediating a midstream interrupt of an itinerary, the method comprising:
receiving an itinerary from a traveler at a pacted central processing system, said pacted system linking a group of service providers and a group of travelers, wherein the pacted central processing system enables:
each service provider, included in the group of service providers, to electronically communicate with an anonymous traveler, included in the group of travelers; and
each traveler, included in the group of travelers, to electronically communicate anonymously with a service provider, included in the group of travelers;
committing the itinerary to the pacted central processing system;
generating a unique identifier that identifies the itinerary and the traveler at the pacted central processing system;
transmitting the unique identifier from the pacted central processing system to the traveler;
anonymously booking, using the unique identifier, the itinerary by the pacted central processing system, said booking comprising transmitting the unique identifier to one or more service providers identified in the itinerary;
receiving, at the pacted central processing system, data relating to an interrupt in the itinerary; and
remediating, by the pacted central processing system, the interrupt in the itinerary.

6. The method of claim 5, wherein the data relating to the interrupt is received from the one or more service providers.

7. The method of claim 6, further comprising triggering an alert when the traveler fails to arrive within a predetermined time period at one of the one or more service providers.

8. The method of claim 5, wherein the data relating to the interrupt is received from the traveler.

9. The method of claim 5, wherein the remediating the interrupt comprises transmitting, from the pacted central processing system, an electronic message to the traveler.

10. The method of claim 5, wherein the remediating the interrupt comprises transmitting, from the pacted central processing system, an electronic message to the traveler, said electronic message comprising an artificially-intelligent-based replacement itinerary.

11. The method of claim 5, wherein:
the itinerary comprises a plurality of legs; and
the remediating the interrupt comprises identifying one or more legs included in the plurality of legs that are incomplete.

12. The method of claim 11 further comprising:
transmitting an electronic message to at least one service provider, included in the plurality of service providers, that are associated with the incomplete legs, said electronic message comprising data relating to the interrupt; and
preemptively cancelling bookings at the at least one service provider associated with the incomplete leg.

13. The method of claim 12 further comprising based on a number of incomplete legs, lowering, by a predetermined amount, a rating of the traveler.

14. A method for remediating a midstream interrupt of an itinerary, the method comprising:
receiving, from a traveler, an itinerary and identification documentation at a pacted central processing system;
committing the itinerary to the pacted central processing system;
generating a unique identifier that identifies the itinerary and the traveler at the pacted central processing system;
transmitting the unique identifier from the pacted central processing system to the traveler;
anonymously booking, using the unique identifier, the itinerary by the pacted central processing system, said booking comprising transmitting an encrypted version of the identification documentation and the unique identifier to one or more service providers identified in the itinerary;
receiving, at the pacted central processing system, data relating to an interrupt in the itinerary; and
remediating the interrupt to the itinerary.

15. The method of claim 14, wherein:
the itinerary comprises a plurality of legs; and
the remediating the interrupt comprises identifying one or more legs, included in the plurality of legs, that are incomplete.

16. The method of claim 15 further comprising notifying at least one service provider, included in the one or more service providers, that are associated with the incomplete legs.

17. The method of claim 14, wherein the remediating comprises transmitting an encryption key to the one or more service providers associated with the incomplete legs, said encryption key operable to decrypt the identification documentation.
